(19) United States
(12) Patent Application Publication
(10) Pub. No.: US 2009/0259370 A1
(43) Pub. Date: Oct. 15, 2009

(54) Vehicle Integrated-Control Apparatus and Vehicle Integrated-Control Method

(75) Inventors: Masato Kaigawa, Toyota-shi (JP); Seiji Kuwahara, Toyota-shi (JP); Ken Koibuchi, Hadano-shi (JP); Hirotada Otake, Susono-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 11/885,668

(22) PCT Filed: Apr. 12, 2006
(86) PCT No.: PCT/IB2006/000846

§ 371 Date: Sep. 5, 2007

(30) Foreign Application Priority Data
Apr. 15, 2005 (JP) 2005-118380

(51) Int. Cl. B60W 10/00; B60W 10/04; B60W 10/18; B60W 10/10; B60W 30/02

(52) U.S. Cl. 701/48

(57) ABSTRACT

The invention relates to a vehicle integrated-control apparatus and method that controls at least a drive control system, a brake control system, and a dynamic behavior control system in an integrated manner. A temporary control target (F0) is set in response to the operation of an input member operated by a driver: a signal indicating the temporary control target (F0) is transmitted to the dynamic behavior control system: the temporary control target (F0) is partitioned into a control target allocated to the drive control system and a control target allocated to the brake control system based on a predetermined allocation rate: a signal indicating a post-partition control target (F1) is output to the appropriate system for achieving the post-partition control target (F1): an instruction from the dynamic behavior control system to correct the temporary control target (F0) is received: the temporary control target (F0) is corrected in accordance with the instruction from the dynamic behavior control system: and a signal indicating a corrected control target (F3) is output to the appropriate system for achieving the corrected control target (F3).

### BACKGROUND OF THE INVENTION

1. Field of the Invention

The invention relates to a vehicle integrated-control apparatus that includes at least a drive control system, which controls driving force generating devices; a brake control system, which controls braking force generating devices; and a dynamic stability control system, which stabilizes a dynamic behavior of a vehicle. The vehicle integrated-control apparatus controls at least these three systems in an integrated manner. The invention also relates to a vehicle integrated-control method for controlling at least the three systems.

2. Description of the Related Art

Japanese Patent Application Publication No. JP-A05-85228 describes a vehicle integrated-control system in which control elements are hierarchically arranged. In the described vehicle integrated-control system, during the process of converting the inputs of a driver into a predetermined operation mode, at least one control element at a high hierarchical level passes the signal indicating the mode down to control elements at lower hierarchical levels. The lower-level systems are instructed to establish the mode indicated by the control elements at the higher hierarchical level.

However, in vehicle integrated-control systems employing such a hierarchical structure, the control elements are not sufficiently independent of each other. As such, any failure that occurs in a control element at a higher hierarchical level may adversely affect the control elements at lower hierarchical levels, and the entirety of the structure is severely affected. Thus, such vehicle integrated-control systems are not sufficiently fail-safe.

To address this problem, alternative arrangements have been employed in vehicle integrated-control apparatuses where control systems are grouped by function, for example, into a drive control system that controls driving force generating devices, a brake control system that controls braking force generating devices, and a dynamic stability control system that stabilizes a dynamic behavior of a vehicle, and these systems are controlled in an integrated manner while exchanging information.

Nonetheless, information exchange between the systems is generally inefficient. Due to such inefficiency in communication between the systems, it is difficult to set an appropriate control target.

### SUMMARY OF THE INVENTION

The invention provides a vehicle integrated-control apparatus and method that sets and achieves an appropriate control target, and that is not easily affected, for example, by delays in communication, while maintaining excellent fail-safe properties.

A first aspect of the invention relates to a vehicle integrated-control apparatus that includes at least a drive control system which controls driving force generating devices, a brake control system which controls braking force generating devices, and a dynamic behavior control system which stabilizes a dynamic behavior of a vehicle. The vehicle integrated-control apparatus controls at least the drive control system, the brake control system, and the dynamic behavior control system in an integrated manner. The vehicle integrated-control apparatus includes temporary-setting means for setting a temporary control target based on the operation amount of an input member operated by a driver; transmitting means for transmitting a signal indicating the temporary control target to the dynamic behavior control system; first output means for partitioning the temporary control target into a control target allocated to the drive control system and a control target allocated to the brake control system based on a predetermined allocation rate, and outputting a signal indicating the post-partition control target to the appropriate system for achieving the post-partition control target; reception means for receiving instructions from the dynamic behavior control system to correct the temporary control target; correction means for correcting the temporary control target in accordance with the instructions from the dynamic behavior control system; and second output means for outputting a signal indicating a corrected control target, derived after correction by the correction, means, to the appropriate system for achieving the corrected control target.

A second aspect of the invention relates to a vehicle integrated-control method for controlling, in an integrated manner, at least a drive control system that controls driving force generating devices, a brake control system that controls braking force generating devices, and a dynamic behavior control system that stabilizes a dynamic behavior of a vehicle. In the vehicle integrated-control method according to the invention, a temporary control target is set based on an operation amount of an input member operated by a driver. A signal indicating the temporary control target is transmitted to the dynamic behavior control system, and the temporary control target is partitioned into a control target allocated to the drive control system and a control target allocated to the brake control system based on a predetermined allocation rate. A signal indicating the post-partition control target is output to the appropriate system for achieving the post-partition control target. Instructions from the dynamic behavior control system are received to correct the temporary control target, and the temporary control target is corrected in accordance with the instructions from the dynamic behavior control system. A signal indicating a corrected control target, derived after correction, is then output to the appropriate system for achieving the corrected control target.

In the first and second aspects, the dynamic behavior control system outputs a signal indicating an absolute amount, which should replace the temporary control target, rather than a relative amount by which the temporary control target should be changed. Also, when the temporary control target is corrected, a higher priority may be given to the instructions from the dynamic behavior control system than to the temporary control target.

Thus, it is possible to provide a vehicle integrated-control apparatus and method that sets and achieves an appropriate control target, and that is not easily affected, for example, by delays in communication, while maintaining excellent fail-safe properties.

### BRIEF DESCRIPTION OF THE DRAWINGS

The features of the invention and advantages thereof, as well as the technical and industrial significance of this invention, will be better understood by reading the following detailed description of preferred embodiments of the invention, when considered in connection with the accompanying drawings, in which:

FIG. 1 illustrates the plan view a vehicle including a vehicle integrated-control apparatus according to the invention; and

FIG. 2 illustrates the system diagram of the vehicle integrated-control apparatus according to an embodiment of the invention.

### DETAILED DESCRIPTION OF THE EXAMPLE EMBODIMENT

In the following description and accompanying drawings, the invention will be described in more detail in terms of an example embodiment. First, a general description of devices to be controlled in a vehicle provided with a vehicle integrated-control apparatus according to the invention will be provided.

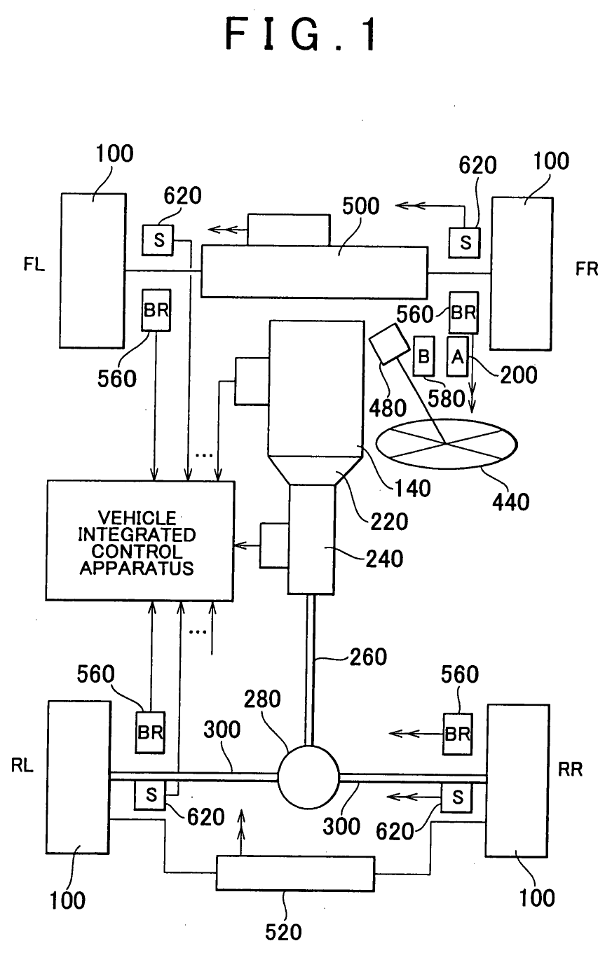

The vehicle is provided with right and left front wheels 100 and right and left rear wheels 100. In FIG. 1, “FR” denotes the right front wheel, “FL” denotes the left front wheel, “RR” denotes the right rear wheel, and “RL” denotes the left rear wheel.

The vehicle includes an engine 140 as a power source. The power source is not limited to an engine. An electric motor may be used as the sole power source. Alternatively, an engine and an electric motor may be used in combination as the power source. The power source for the electric motor may be a secondary battery or a fuel cell.

The operating state of the engine 140 is electrically controlled based on the operation amount of an accelerator pedal 200 (one of the input members operated by the driver to control the forward movement, backward movement, speed, or acceleration of the vehicle) by the driver. If necessary, the operating state of the engine 140 may be automatically controlled independently of the operation of the accelerator pedal 200 by the driver.

The engine 140 is electrically controlled by electrically controlling, for example, the opening amount of a throttle valve (not shown) (hereinafter, referred to as a “throttle valve opening amount”) provided in an intake manifold of the engine 140, the amount of fuel injected into a combustion chamber of the engine 140, or the angular position of an intake camshaft that adjusts the valve opening/closing timing.

The example vehicle is a rear-wheel drive vehicle where the right and left front wheels are the driven wheels and the right and left rear wheels are the drive wheels. Accordingly, the output shaft of the engine 140 is connected to the right and left rear wheels via a torque converter 220, a transmission 240, a propeller shaft 260, a differential gear unit 280, and a drive shaft 300 that rotates along with the rear wheels. The torque converter 220, the transmission 240, the propeller shaft 260, and the differential gear unit 280 are power transmission elements shared by the right and left rear wheels. However, the application of vehicle integrated-control apparatus according to the embodiment is not limited to rear-wheel drive vehicles. The vehicle integrated-control apparatus may be applied, for example, to front-wheel drive vehicles where the right and left front wheels are the drive wheels and the right and left rear wheels are the driven wheels. Also, the vehicle integrated-control apparatus may be applied to four-wheel drive vehicles where all the wheels are the drive wheels.

The transmission 240 is an automatic transmission. The automatic transmission electrically controls the speed ratio, based on which the speed of the engine 140 is converted into the rotational speed of the output shaft of the transmission 240. This automatic transmission may be either a stepped transmission or a continuously variable transmission (CVT).

The vehicle includes a steering wheel 440 operated by the driver. A steering reaction force supply device 480 electrically supplies the steering wheel 440 with a steering reaction force, that is, a reaction force corresponding to the operation of the steering wheel 440 performed by the driver (hereinafter, sometimes referred to as “steering”). The steering reaction force can be electrically controlled.

The orientation of the right and left front wheels, namely, the steering angle of the front wheels is electrically controlled by a front steering device 500. The front steering device 500 controls the steering angle of the front wheels based on the angle by which the driver has turned the steering wheel 440. If necessary, the front steering device 500 may automatically control the steering angle of the front wheels independently of the operation of the steering wheel 440 by the driver. In other words, the steering wheel 440 may be mechanically isolated from the right and left front wheels.

Similarly, the orientation of the right and left rear wheels, namely, the steering angle of the rear wheels is electrically controlled by a rear steering device 520.

The wheels 100 are provided with respective brakes 560 that are applied to suppress rotation of the wheels 100. The brakes 560 are electrically controlled based on the operation amount of a brake pedal 580 (one of the input members operated by the driver to control the forward movement, backward movement, speed, or acceleration of the vehicle) by the driver. If necessary, the wheels 100 may be individually and automatically controlled.

In the example vehicle, the wheels 100 are connected to the vehicle body (not shown) via respective suspensions 620. The suspension properties of each suspension 620 can be electrically controlled independently of the other suspensions 620.

The following actuators are used to electrically control the corresponding components described above:
(1) an actuator that electrically controls the engine 140;
(2) an actuator that electrically controls the transmission 240;
(3) an actuator that electrically controls the steering reaction force supply device 480;
(4) an actuator that electrically controls the front steering device 500;
(5) an actuator that electrically controls the rear steering device 520;
(6) actuators that electrically control the brakes 560; and
(7) actuators that electrically control the suspensions 620.

Only commonly used actuators are listed above. Whether all the actuators listed above are required depends on the specifications of the vehicles. Some vehicles do not include one or more actuators listed above. Alternatively, other vehicles may include other actuators, in addition to the actuators listed above, such as an actuator used to electrically control the ratio between the steering amount of the steering wheel 440 and the steered amount of the steered wheel (steering ratio), and an actuator used to electrically control a reaction force of the accelerator pedal 200. Accordingly, the invention is not limited to the particular actuator configurations mentioned above.

As shown in FIG. 1, the vehicle integrated-control apparatus that is mounted in the vehicle is electrically connected to the various actuators described above. A battery (not shown) serves as the electric power source for the vehicle integrated-control apparatus.

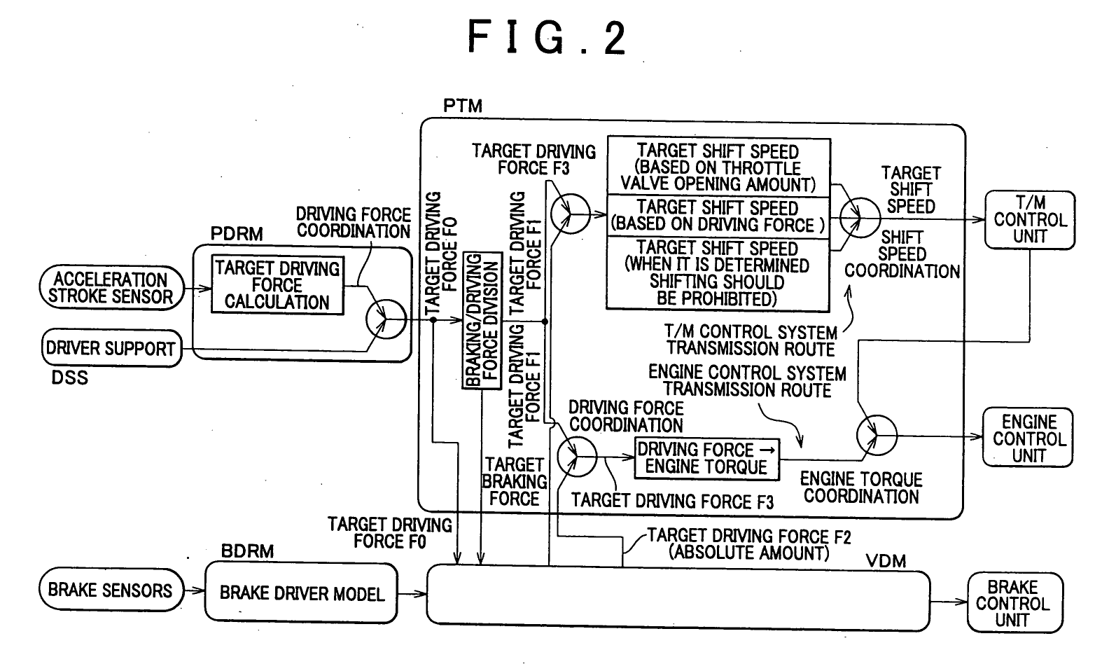

FIG. 2 illustrates the system diagram of the vehicle integrated-control apparatus according to the embodiment of the invention. The vehicle integrated-control apparatus mainly includes a drive control system that controls the engine 140 and the transmission 240, a brake control system that controls the brakes 560, and a dynamic stability control system that stabilizes a dynamic behavior of a vehicle. The vehicle integrated-control apparatus controls at least these three systems in an integrated manner.

As in the case of a commonly used ECU (electronic control unit), each manager (and model) described below may be a microcomputer that includes, for example, ROM that stores control programs, RAM where results of calculations and the like are stored and the data can be retrieved and/or updated, a timer, a counter, an input interface, an output interface, and the like. In the following description, the control units are grouped by function, and referred, for example, to as a P-DRM, a VDM, and the like. However, the P-DRM, the VDM, and the like need not be configurations physically independent of each other. The P-DRM, the VDM, and the like may be configured integrally with each other using an appropriate software structure.

At the highest level of the drive control system, a manager that functions as a driver's intention determining portion of the drive control system (hereinafter, referred to as a “P-DRM”: Power-Train Driver Model) is arranged.

At the level superior to the P-DRM, an acceleration stroke sensor is arranged. The acceleration stroke sensor produces an electric signal corresponding to the operation amount of the accelerator pedal 200, which directly reflects the input of the driver.

At the level superior to the P-DRM, a driver support system (hereinafter, referred to as a “DSS”: Driver Support System”) is arranged in parallel with the acceleration stroke sensor. The DSS provides an appropriate instruction as an alternative to the input of the driver or an appropriate instruction to make a correction to the input of the driver, based on the information concerning obstacles located around the vehicle, which is captured, for example, by a camera or a radar, the road information and ambient area information obtained from a navigation system, the current position information obtained from a GPS positioning device of the navigation system, or various information obtained via communication with the operation center, vehicle-to-vehicle communication or road-to-vehicle communication. Examples of the instructions include an instruction from the DSS during the automatic cruise control or the automatic or semi-automatic running control similar to the automatic cruise control, and an instruction from the DSS while the intervention-deceleration control or steering assist control is performed, for example, to avoid an obstacle.

In the P-DRM, the electric signal transmitted from the acceleration stroke sensor is converted into a signal indicating a target driving force F0 by a target driving force calculation portion, and then output to a power train manager (hereinafter, referred to as a “PTM”: Power-Train Manager) arranged at the level subordinate to the P-DRM. If an instruction is transmitted from the DSS, the target driving force F0 calculated by the target driving force calculation portion is corrected in accordance with the instruction from the DSS. The target driving force F0 may be calculated using at least one map where the relationship between the target driving force F0 and the accelerator pedal operation amount indicated by the electric signal transmitted from the acceleration stroke sensor is defined in advance.

While not shown in FIG. 1 for convenience of illustration, in addition to the electric signal from the acceleration stroke sensor, signals from a shift control system (e.g. a signal indicating the shift position and a signal from a pattern select switch) may be input in the P-DRM. In this case, these signals are interpreted as indicating the intention of the driver, and, if necessary, used to correct the target driving force F0.

At the highest level of the brake control system, a manager that serves as a driver's intention determining portion of the brake control system (hereinafter, referred to as a “B-DRM”: Brake Driver Model) is arranged.

At the level superior to the B-DRM, a brake sensor is arranged. The brake sensor produces an electric signal indicating the operation amount of the brake pedal 580 that directly reflects the input of the driver. The brake sensor may be a master-cylinder pressure sensor, a brake depression force sensor, or the like.

In the B-DRM, the electric signal from the brake sensor is converted into a signal indicating the target braking force by a target braking force calculation portion (not shown), and output, via a manager for the dynamic stability control system (hereinafter, referred to as a “VDM”: Vehicle Dynamics Manager) arranged at the level subordinate to the B-DRM, to a brake control unit that controls the actuators for the brakes 560. While not described in detail in this specification, the target braking force calculated by the target braking force calculation portion is output to the brake control unit after being corrected in the same or similar manner in which the target driving force F0 is corrected.

As described above, the PTM and the VDM are arranged in parallel at the levels subordinate to the P-DRM and the B-DRM, respectively.

The PTM is a manager that functions as an instruction coordination portion of the drive control system.

The PTM receives a signal indicating the target driving force F0 from the P-DRM. If necessary, the target driving force F0 is partitioned into a target driving force F1 and a target braking force by a braking/driving force partitioning portion. Namely, the target driving force F0 indicated by the signal from the P-DRM is partitioned into the target driving force F1 and the target braking force based on the ratio between the force allocated to the drive control system and the force allocated to the brake control system. The manner of partitioning may be such that a signal indicating a target braking force, that is, the braking force, which corresponds to the shortfall in the braking force generated by the drive control system, is input in the brake control system. The manner of partitioning may be set in advance based on the amount of braking force that can be generated by an engine brake, or the amount of braking force that can be generated by a regenerative brake in the case of an electric vehicle.

The signal, indicating the target braking force, that is input in the brake control system is transmitted to the brake control unit, after the target braking force is coordinated, if necessary, with the target braking force calculated by the B-DRM.

The signal indicating the post-partition target driving force F1 derived after partitioning the target driving force F0 (if partition of the target driving force F0 is not necessary, the target driving force F1 remains equal to the target driving force F0) is transmitted via two signal lines, and used to control the engine 140 and the transmission 240. Hereafter, the two routes through which the signals indicating the post-partition target driving force F1 is transmitted will be referred to as an “engine control system transmission route” and a “T/M control system transmission route”.

The VDM is a manager that functions as a vehicle movement coordination portion. Examples of such system that stabilizes the dynamic behavior of the vehicle include a traction control system (a system that suppresses unnecessary wheelspin of the drive wheels that is likely to occur when the vehicle starts or accelerates on a slippery road), a system that suppresses a side skid that is likely to occur when the vehicle enters a slippery road, a system that stabilizes the orientation of the vehicle to prevent the vehicle from spinning or sliding off the track if the stability reaches its limit when the vehicle is going round a curve, and a system that actively makes a difference in the driving force between the right and left rear wheels of the four-wheel drive vehicle, thereby causing a yaw moment.

While not shown, at the level subordinate to the VDM, a control unit that controls the actuators for the front steering device 500 and the rear steering device 520, and a control unit that controls the actuators for the suspensions 620 are arranged in parallel with the brake control unit described above.

The target braking force is primarily determined based mainly on the input of the driver. The VDM secondarily provides an instruction to correct the target braking force to stabilize the dynamic behavior of the vehicle. In this case, the target driving force, indicated by the signal transmitted to the VDM, is the pre-partition target driving force F0, not the post-partition target driving force F1. If necessary, the VDM provides an instruction to correct the pre-partition target driving force F0 indicated by the signal transmitted from an element at a level superior to the braking/driving force partitioning portion. Preferably, the correction instruction from the VDM specifies the replacement of the pre-partition target driving force F0 with an absolute amount, instead of a correction amount AF by which the pre-partition target driving force F0 should be increased or decreased. Hereafter, the absolute amount of the target driving force instructed by the VDM based on the pre-partition target driving force F0 will be referred to as a “target driving force F2”.

As shown in FIG. 2, a signal indicating the target driving force F2 is input in an element at the level subordinate to the braking/driving force partitioning portion in the PTM. As shown in FIG. 2, the signal indicating the target driving force F2 is input in each of the engine control system transmission route and the T/M control system transmission route. At the input portion of each route, the target driving force F2 is coordinated with the “post-partition target driving force F1” indicated by the signal from the braking/driving force partitioning portion. In this coordination process, preferably, a higher priority is given to the target driving force F2 than to the “post-partition target driving force F1”, because a higher priority should be given to a stable dynamic behavior of the vehicle. Alternatively, the final target driving force may be derived by appropriately assigning weights to the target driving force F2 and the target driving force F1. To give a higher priority to the stable dynamic behavior of the vehicle, greater weight should be assigned to the target driving force F2 than the weight assigned to the target driving force F1. The target driving force derived through such coordination process will be referred to as a “target driving force F3”.

In the T/M control system transmission route, a signal indicating the target driving force F3, derived after such coordination process, is input in a target shift speed setting portion, as shown in FIG. 2. The target shift speed setting portion sets the final target shift speed by appropriately coordinating a target shift speed that is set based on the throttle valve opening amount indicated by a signal transmitted through a route, not shown in FIG. 2, a target shift speed that is set based on the target driving force F3, and a target shift speed that is set when it is determined that shifting should be prohibited.

A signal indicating the target shift speed thus set in the PTM is output to the T/M control unit arranged at the level subordinate to the PTM. The T/M control unit controls the actuator for the transmission 240 to achieve the target shift speed indicated by the signal received.

In the engine control system transmission route, a conversion portion converts the mode of expressing the target driving force F3 from the mode where it is expressed by the driving force (N) to the mode where it is expressed by the engine torque (N×m), as shown in FIG. 2. Then, the target driving force F3 is coordinated with an instructed engine torque indicated by a signal transmitted from the T/M control unit to the PTM, and a signal indicating target driving force F3, derived after such coordination process, is output to the engine control unit arranged at the level subordinate to the PTM. The engine control unit controls the actuator for the engine 140 to achieve the target engine torque indicated by the signal from the PTM.

The embodiment described so far relates to the vehicle integrated-control apparatus where the transmission systems that transmit the input of the driver to the actuators at the lowest level are grouped, by function, into the drive control system and the brake control system, and these systems are controlled in an integrated manner by exchanging information between the systems and between the systems and the DVM. Thus, a failure that occurs in one system is unlikely to have any significant adverse affects on the entirety of the apparatus, which enhances the fail-safe properties of the system.

In addition, according to the embodiment described above, the signal indicating the pre-partition target driving force F0 is transmitted to the VDM, and the VDM provides an instruction to correct the pre-partition target driving force F0 indicated by the signal received. Conventionally, the VDM receives the signals indicating the post-partition target driving force F1 and the target braking force, which are derived by partitioning the pre-partition target driving force F0, from the drive control system and the brake control system, respectively, and provides separate instructions to correct the post-partition target driving force F1 and the target braking force. In this case, the signals indicating the post-partition target driving force F1 and the target braking force are received from the drive control system and the brake control system through the different communication lines, respectively. Then, the post-partition target driving force F1 and the target braking force are coordinated and integrated with each other (returned to the pre-partition target driving force). Then, whether a correction instruction should be provided is determined, and, if so, the correction amount is set. As a result, delays in communication and inefficiency in exchanging the information may occur. In contrast, according to the embodiment, the signal indicating the pre-partition target driving force F0 is transmitted to the VDM via only one communication line. As a result, delays in communication and the like are reduced in comparison with conventional configurations.

In addition, according to the embodiment described above, the VDM provides instructions to have the target driving force corrected using the absolute amount. Conventionally, the VDM provides an instruction to correct the target driving force using a correction amount (relative amount) by which the target driving force should be increased or decreased. In this case, the target driving force indicated by the signal transmitted to the VDM needs to be coordinated with the correction amount in accordance with the correction instruction from the VDM. If the coordination is not appropriately established, the correction instruction from the VDM cannot be reflected on the final target driving force, which may result in an inappropriate correction. In contrast, according to the embodiment, the correction instruction specifies an absolute amount. Accordingly, even if the coordination is not appropriately established, it is still possible to appropriately correct the target driving force in accordance with the instruction from the VDM by giving a higher priority to the correction instruction from the VDM. As a result, the fail-safe properties can be enhanced.

The embodiment of the invention that has been described in the specification is to be considered in all respects as illustrative and not restrictive. The technical scope of the invention is defined by claims, and all changes which come within the meaning and range of equivalency of the claims are therefore intended to be embraced therein.

For example, in the embodiment described above, the invention applied to the drive control system is described particularly in detail. However, the invention may also be applied to the brake control system. Namely, if necessary, the VDM may provide an instruction to correct the target braking force that is derived after partitioning the pre-partition target driving force F0 indicated by the signal transmitted from the PTM. In this case, the correction instruction may be provided using the absolute amount, as described above.

In the embodiment, the engine 140 includes an electronic throttle valve, and is used as the power source. However, the invention may be applied to a configuration where the motor without an electronic throttle valve is used as the power source.

1-14. (canceled)

15. A vehicle integrated-control apparatus that includes at least a drive control system which controls driving force generating devices; a brake control system which controls braking force generating devices; and a dynamic behavior control system which stabilizes a dynamic behavior of a vehicle, and that controls at least the drive control system, the brake control system, and the dynamic behavior control system in an integrated manner, comprising:
a temporary-setting device that sets a temporary target driving force based on an operation amount of an input member of the drive control system operated by a driver;
a transmitting device that transmits a signal indicating the temporary target driving force to the dynamic behavior control system;
a first output device that partitions the temporary target driving force into a post-partition target driving force allocated to the drive control system and a control target allocated to the brake control system based on a predetermined allocation rate, and outputting a signal indicating the post-partition target driving force, derived after partition, to at least one of second output devices;
a reception device that receives an instruction from the dynamic behavior control system to correct the temporary target driving force; and
a correction device that corrects the temporary target driving force in accordance with the instruction from the dynamic behavior control system; wherein
the at least one of second output devices outputs a signal indicating a corrected target driving force, derived after coordination of the post-partition control target output from the first output device with the temporary target driving force as corrected by the correction device, to the drive control system.

16. The vehicle integrated-control apparatus according to claim 15, wherein
the dynamic behavior control system outputs a signal to the correction device instructing the correction device to correct the temporary target driving force by replacing the temporary target driving force with an absolute amount rather than a relative amount by which the temporary target driving force should be changed.

17. The vehicle integrated-control apparatus according to claim 15, wherein
an amount of a correction requirement is calculated based on the temporary target driving force in the dynamic behavior control system.

18. The vehicle integrated-control apparatus according to claim 15, wherein
the correction device gives a higher priority to the instruction from the dynamic behavior control system than to the post-partition target driving force.

19. The vehicle integrated-control apparatus according to claim 15, wherein
the correction device corrects the target driving force distributed by the first output device based on the instruction from the dynamic behavior control system.

20. The vehicle integrated-control apparatus according to claim 15, further comprising:
two second output devices, wherein
the temporary target driving force as corrected by the correction device is individually calculated for each of said two second output devices.

21. The vehicle integrated-control apparatus according to claim 20, wherein
one of second output devices is attributed to a transmission control unit and the other is attributed to an engine control unit.

22. A vehicle integrated-control method for controlling, in an integrated manner, at least a drive control system that controls driving force generating devices, a brake control system that controls braking force generating devices, and a dynamic behavior control system that stabilizes a dynamic behavior of a vehicle, comprising:
setting a temporary target driving force based on an operation amount of an input member of the drive control system operated by a driver;
transmitting a signal indicating the temporary target driving force to the dynamic behavior control system;
partitioning the temporary target driving force into a post-partition target driving force allocated to the drive control system and a control target allocated to the brake control system based on a predetermined allocation rate, and outputting a signal indicating the post-partition target driving force, derived after partition;
receiving an instruction from the dynamic behavior control system to correct the temporary target driving force;
correcting the temporary target driving force in accordance with the instruction from the dynamic behavior control system;
coordinating the post-partition control target with the temporary target driving force as corrected in accordance with the instruction from the dynamic behavior control system; and
outputting a signal indicating a corrected target driving force, derived after the coordination, to the drive control system.

23. The vehicle integrated-control method according to claim 22, wherein
the dynamic behavior control system outputs a signal indicating an absolute amount, which should replace the temporary target driving force, rather than a relative amount by which the temporary target driving force should be changed.

24. The vehicle integrated-control method according to claim 22, wherein
an amount of a correction requirement is calculated based on the temporary target driving force in the dynamic behavior control system.

25. The vehicle integrated-control method according to claim 22, wherein
a higher priority is given to the instruction from the dynamic behavior control system than to the temporary post-partition target driving force.

26. The vehicle integrated-control method according to claim 22, wherein
the temporary target driving force distributed by the first output device is corrected based on the instruction from the dynamic behavior control system.

27. The vehicle integrated-control method according to claim 22, further comprising:
two second output devices, wherein
the temporary target driving force in accordance with the instruction from the dynamic behavior control system is individually calculated for each of said two second output devices.

28. The vehicle integrated-control method according to claim 27, wherein
one of said second output devices is attributed to a transmission control unit and the other is attributed to an engine control unit.
